(19) United States
(12) Patent Application Publication
(10) Pub. No.: US 2017/0126785 A1
(43) Pub. Date: May 4, 2017

(54) APPARATUSES, SYSTEMS, AND METHODS FOR COLLABORATION

(71) Applicant: SourcePop LLC, Morgantown, WV (US)

(72) Inventors: Patrick R. Esposito, II, Morgantown, WV (US); Jay P. Wilhelm, Morgantown, WV (US)

(21) Appl. No.: 14/928,935

(22) Filed: Oct. 30, 2015

(51) Int. Cl. H04L 29/08; H04L 29/06

(52) U.S. Cl. CPC H04L 67/10; H04L 65/403

(57) ABSTRACT

A system, apparatus, and method for enabling collaboration between people and organizations. A collaboration method includes receiving a collaboration request from a first user, transmitting the collaboration request to a second user, receiving a collaboration response from the second user, transmitting the collaboration response to the first user, creating a Talk thread that includes the collaboration request and response, receiving a link to a remotely stored document related to the collaboration requested, the remotely stored document being accessible to the computer system through a network, receiving a modification to the remotely stored document related to the collaboration and storing that modification in a data storage device coupled to the computer system, and communicating the document link to the first user and the second user.

### CROSS-REFERENCE TO RELATED APPLICATIONS

None.

### FIELD OF THE INVENTION

The present invention is concerned with enabling people and organizations to collaborate efficiently. Embodiments of the invention: associate files stored outside the collaboration apparatuses, systems, and methods with a collaboration conducted on the collaboration apparatuses, systems, and methods; facilitate contracting associated with collaboration by connecting information related to the collaboration with a contract or request associated with contracting; associate collaboration information with a request for proposal; and score users to indicate the likelihood the scored user will be able to provide valuable assistance with a desired collaboration.

### BACKGROUND OF THE INVENTION

Collaboration between people has been thought to be beneficial to solve one or more problems and may be even more valuable as problems in modern society become ever more complex. With the advent of networks, such as the Internet, it has become more viable to collaborate with people who are in remote locations, rather than bringing people together in a single facility, as has been done in research laboratories in recent decades.

While electronic mail and even package and correspondence delivery have contributed to non-face-to-face collaboration, it is believed that expanding the capability to collaborate through a network would benefit collaboration.

It is also thought that providing tie-ins to a collaboration system to add functionality beyond pure collaboration would be beneficial.

It is thought that assisting with contracting for consulting services in a collaboration system would be beneficial. It is further thought that inclusion of information related to a collaboration with a contract or request for proposal relating to such a contract would be beneficial.

It is thought that the ability to incorporate files in third party storage facilities into collaborations could be a beneficial addition to a collaboration system.

It is further thought that having a collaboration apparatus, system, or method to score potential collaborators based on the likelihood the scored user will provide significant collaboration assistance would be beneficial.

### SUMMARY OF THE INVENTION

Embodiments of collaboration apparatuses, systems, and methods are directed to assisting people and entities with finding and conducting collaborations to accomplish goals.

Embodiments of the present collaboration apparatuses, systems, and methods may provide a variety of tools to encourage or advance collaboration activities.

In accordance with one embodiment of a collaboration system, the collaboration system includes a processor coupled to a data storage device and a network, such as the Internet or an intranet. The data storage device may be used for storing files of information related to a collaboration project, including Source or resource files, Talk, which may include discussion threads or other documented exchanges related to a collaboration, and Work, which may include collaboration work products. The processor may include instructions which, when executed by the processor, cause the processor to receive a collaboration request from a first user operating on a first node, transmit the collaboration request to at least a second node, receive a collaboration response from the second node, transmit the collaboration response to the first node, create a Talk thread that includes collaboration requests and responses, receive one or more links to one or more documents related to the collaboration requested, those documents not being stored on the data storage device but being accessible through the Internet or another network, receive a modification to the document related to the collaboration and store that modification in the data storage device, and communicate the document link to at least the first node and the second node.

In accordance with an embodiment of a collaboration method of the present invention, the method includes a computer system: receiving a collaboration request from a first user, transmitting the collaboration request to at least a second user, receiving a collaboration response from the second user, transmitting the collaboration response to the first user, creating a Talk thread that includes collaboration requests and responses, receiving one or more links to one or more documents related to the collaboration requested, those documents being stored remotely from the system and accessible to the system through the Internet or another network, receiving a modification to the document related to the collaboration and storing that modification in a data storage device coupled to the system, and communicating the document link to at least the first node and the second node.

Accordingly, the present invention provides solutions to the shortcomings of prior collaboration apparatuses, systems, and methods. Those of ordinary skill in the art will readily appreciate, therefore, that those and other details, features, and advantages of the present invention will become further apparent in the following detailed description of the preferred embodiments of the invention.

### BRIEF DESCRIPTION OF THE DRAWINGS

The accompanying drawings, which are incorporated herein and constitute part of this specification, include one or more embodiments of the invention, and together with a general description given above and a detailed description given below, serve to disclose principles of embodiments of collaboration apparatuses, methods, systems, and networks.

FIG. 1 illustrates an embodiment of a collaboration network;

FIG. 2 illustrates information available in an embodiment of work collaboration;

FIG. 3 illustrates an embodiment of the exchange of domain and network information with user information to create ratings;

FIG. 4 illustrates an embodiment of Pop operation in an embodiment of work collaboration apparatuses, systems, and methods;

FIG. 5 illustrates an embodiment of Work administrator interaction with the work collaboration apparatuses, systems, and methods;

FIG. 6 illustrates a contracting selection process that may be used to support collaborative work that is fee-based;

FIG. 7 illustrates a mobile device that may be used in embodiments of collaboration apparatuses, systems, and methods; and

FIG. 8 illustrates computing device hardware that may be used in embodiments of collaboration apparatuses, systems, and methods.

### DETAILED DESCRIPTION OF THE INVENTION

Reference will now be made to embodiments of collaboration apparatuses, systems, and methods, examples of which are illustrated in the accompanying drawings. Details, features, and advantages of those collaboration apparatuses, systems, and methods will become further apparent in the following detailed description of embodiments thereof. It is to be understood that the figures and descriptions included herein illustrate and describe elements that are of particular relevance to collaboration apparatuses, systems, and methods, while eliminating, for purposes of clarity, other elements found in typical computerized and networking systems.

Any reference in the specification to “one embodiment,” “a certain embodiment,” or any other reference to an embodiment is intended to indicate that a particular feature, structure or characteristic described in connection with the embodiment is included in at least one embodiment and may be utilized in other embodiments as well. Moreover, the appearances of such terms in various places in the specification are not necessarily all referring to the same embodiment. References to “or” are furthermore intended as inclusive so “or” may indicate one or another of the ored terms or more than one ored term.

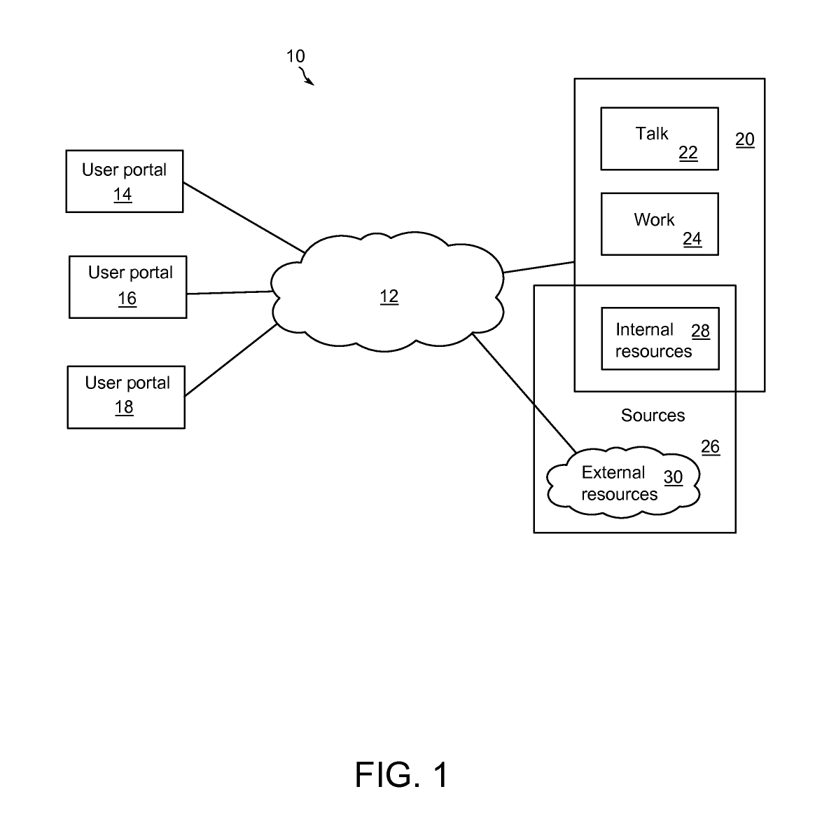

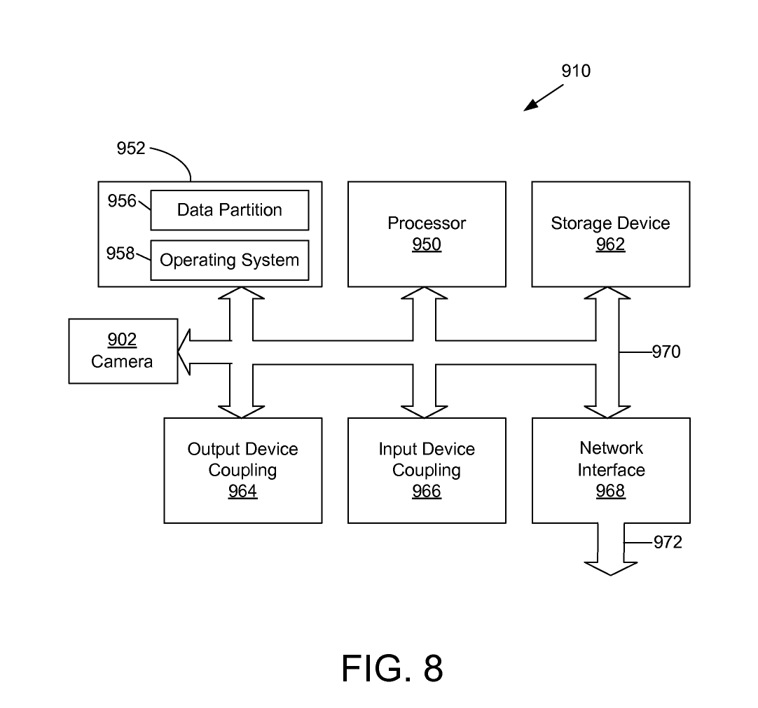

FIG. 1 illustrates an embodiment of a collaboration system 10 that includes a network 12, a plurality of user portals 14, 16, and 18 and one or more servers 20. The servers 20 provide “Talk,” “Work,” and “Source” functionality and the Source resources and files 26 may be stored in the server 20 or a related data storage device (see FIG. 8) as shown at 28 or may be stored external to the collaboration system 10, for example, in a third party data storage device as shown at 30.

The network 12 may be the Internet or a different network and the network may be public or private. In certain embodiments, the network is a network created by or through the collaboration apparatuses, systems, and methods. In embodiments, the network 12 is found under an Internet domain arranged for a particular collaboration or group of collaborations.

The user portals 14, 16, and 18 are nodes coupled to the collaboration network 12. User portals 14, 16, or 18 may be used by members of the collaboration network 12 or people associated, for example by employment or contract, with the collaboration network 12. User portals 14, 16, or 18 may be used, for example, to establish a collaboration item, to respond to a collaboration request, for Talk or communication related to a collaboration item, or for Source work by connecting one or more resources to a collaboration item. User portals 14, 16, and 18 may be any type of processing unit that can be coupled to a network, including general purpose computers, netbooks, tablets, and mobile devices. User portals 14, 16, and 18 may furthermore include various devices including any or all of the devices illustrated and described in connection with FIG. 8.

The server or servers 20 may include one or more computing devices and may include any or all of the devices illustrated and described in connection with FIG. 8. The server 20 may include programming to perform the collaboration functionality discussed herein and to communicate collaboration functionality to the user portals 14, 16, and 18. The collaboration functionality may be performed by executing instructions, which may be stored in the server 20 storage device 962 and executed by its processor 950.

In various embodiments, the collaboration system 10 of FIG. 1 may support apparatuses, systems, and methods for optimizing collaborative work activities through the use of a knowledge-based market network. This knowledge-based market network may combine elements of social networks, marketplaces, resources, communication tools, and intelligent agents that support the delivery of relevant information, conversations, connections, and collaborative work opportunities to participants.

The collaborative work apparatuses, systems and methods, such as the collaboration system 10 in one embodiment, may provide access to potential work collaborators and information. The collaborative work apparatuses, systems and methods may provide functionality to support sharing of information, conversations about subjects related to the work, and resources of common interest. The collaborative work apparatuses, systems and methods may be used to support collaboration on work activities, and may facilitate execution of contract transactions to support the collaborative work. The collaborative work apparatuses, systems and methods may support one or more controlled groups of individual or organizational participants or an open market network of potential collaboration partners. The participants may furthermore be open or may be restricted by factors including, for example, geographic proximity or technologic relatedness.

The collaborative work apparatuses, systems and methods may be embodied in various ways including as a web application, an internally hosted application on a computer, server, or network of computers, a set of application programming interfaces for remote or embedded access, or a mobile app.

The collaborative work apparatuses, systems and methods may allow for registration and sign in through a user account. The collaborative work apparatuses, systems and methods may also allow a user to connect social network accounts and contact books to one or more collaborative work systems or apparatuses to help to search for or invite new users to join the collaborative work apparatuses or systems.

The collaborative work apparatuses, systems and methods may allow for the development and maintenance of a profile for a person or entity member. The profile may include various information related to individuals, individuals that are part of an entity, or the entity itself. Such information may include biographical information, physical or network (e.g., Internet) location information, projects performed or in process, positions held, places of employment, locations of employment, work activities, publications, sample projects, and work samples. The collaborative work apparatuses, systems and methods profile information may also include restrictions, such as types of collaborations in which the person or entity has an interest in participating, limitations of the person or entity, or requirements for those proposing to collaborate with the person or entity.

Embodiments of the collaborative work apparatuses, systems and methods allow for establishing connections to individuals as a social network. Thus, for example, one collaboration desiring member of a collaborative work system may view other members and the profiles for those other members, may select another member with which the collaboration desiring member would like to explore collaboration efforts. The collaboration desiring member may then communicate to the other member through the collaborative work system. That communication may, for example, be text based and may provide basic information about the collaboration the collaboration desiring member would like to explore with the other member. The other member may then provide a responsive communication through the collaborative work system. If the response is positive and expresses an interest by the other party to collaborate with the collaboration desiring member, then those two members may connect through the collaborative work system.

A variety of activities may be conducted through the collaborative work system by connected members. For example, the connected members may use the Talk functionality discussed herein to discuss and agree on what activity they will collaborate, terms for a collaboration, and develop a collaboration from its inception, through its growth, to whatever form the collaboration ultimately takes.

Terms for a collaboration may include request, negotiation, and agreement to a fee for a collaboration or steps to be taken in a collaboration. Steps might include, for example, providing responses to questions, providing feedback on proposed solutions, or providing an opinion on a proposal.

Embodiments of the collaborative work apparatuses, systems and methods allow for participation in a global collaboration domain, such as www.sourcepop.com. Those embodiments or other embodiments of the collaborative work apparatuses, systems and methods allow for formation of and participation in one or more proprietary domains (e.g., xyzcorp.sourcepop.com and stateutechtransfer.sourcepop.com). Those proprietary domains may provide restricted access and they may provide restricted information. Invitations may be provided from proprietary domains to participants to join the domain. Such invitations may furthermore be provided by an administrator of the proprietary domain or by a member of the proprietary domain.

Embodiments of the collaborative work apparatuses, systems and methods allow for formation of and participation in one or more networks on one or more domains. For example, domains such as xyzcorp.sourcepop.com/advancednetworkingtechnologies/ and xyzcorp.sourcepop.com/chemicaltechnologies/ may be created for use by workers in an organization with certain duties related to advanced networking technologies belonging to the softwaredefinednetworking domain, certain workers that perform duties related to a chemical business belonging to the chemicaltechnologies domain and other workers responsible for both areas belonging to both of those domains. The networks housed at those domains may furthermore be public or private, such that, in embodiments, public networks could be open to members to join as those members choose, whereas private networks could have controlled access to new members and one or more administrative members could extend invitations to new members that they desire to join the private network. Members may, furthermore, be individuals or organizations and memberships could be extended to a plurality of people in an organization that is a member.

Where a plurality of people in an organization are invited to join a private network, an administrator of the private network may extend an invitation to one or more people in the organization through an email with a link to the private network, for example, and that or those people in the organization may forward the link to others in the organization who are to join the private network.

Each network may include searchable repositories and records, which may include, for example, written or pictorial documents, and are referred to herein as “Sources,” searchable messages and message threads, also referred to herein as “Talk,” and searchable work collaboration items, also referred to herein as “Work.” New networks may furthermore be created and existing networks may be updated and each network may have its searchable functions, including Talk, Sources, and Work, modified or updated.

Sources in the work collaboration apparatuses, systems, and methods can be any type of resource that could be useful to accomplish a goal, a goal for which collaboration is desired. For example, a Source could be: a document such as a book, article, paper or portion thereof; a writing; a picture or diagram; plans; a voice or video recording; a photograph; or another thing that may be helpful to accomplishing the goal that can be stored in computer memory, or any combination of those things.

In embodiments of work collaboration apparatuses, systems, and methods, Sources can be added, updated, tagged, or commented upon by users, and may include a searchable history of changes or comments.

Sources of information, such as knowledge resources, documents, visual media, or audio files may be added within the system internally or through linking to external sources including, for example, cloud systems, local internal network file storage, Google Drive, Dropbox, Box, SharePoint, YouTube and other sources from which source information may be gleaned or the information from which may be accessible to or through the collaborative work apparatuses, systems and methods.

Talk messaging threads of the collaborative work apparatuses, systems and methods can be added, updated, or tagged in embodiments. Thus, in certain embodiments, a message thread may be begun by a user who, for example, has an issue with a project that they would like assistance in resolving. Other users of the collaborative work system that have access to that message thread may add their comments and responses to the thread. A posting, such as the original message or a comment or response, may be updated, for example, to clarify or correct that posting or to provide additional information learned since the posting. A message thread or one or more postings within a message thread may be tagged by one or more users, for example, because the thread or message provided that user with information they found valuable so that thread may be used by others with access to that thread who have similar problems. Other tags may also be employed, such as a tag to oneself that, though the title of a thread or post made it look like it might be of interest in answering a question or helping to solve a problem, the thread or post was found to be not particularly helpful. Tags, as well as the Talk threads themselves and any Sources associated with the Talk thread, may furthermore be public tags that can be viewed by general users or private for viewing by the tagging user or a defined group only.

Collaborative work apparatuses, systems and methods may provide support for third party resources proliferation of information stored in the apparatuses and systems or third party stored information that is associated with the collaborative work apparatuses, systems and methods, messaging threads between collaborators and with third parties, and development of new Sources that may be stored in the collaborative work apparatuses, systems and methods or with a third party.

Work may be conducted within the collaborative work apparatuses, systems, and methods through linking to external systems, such as, for example, Google Drive, Dropbox, Box, SharePoint, YouTube, or various applications—or information stored on such external systems—or through a combination of resources both on the system and external to the system. Within the collaborative work apparatuses, systems, and methods, Work collaboration items may include Talk threads for written or recorded communications. Those communications may be about Work, as well as additional Sources and sub-level Work.

Thus, the collaborative work apparatuses, systems, and methods could rely on information delivered, accessed and manipulated both inside of the system and outside of the system for the Sources and Work functions and that may provide a significant enhancement to existing collaboration practices. The outside Sources and Work integration into the present collaborative work apparatuses, systems, and methods may include the ability for real-time, two-way integration and normalization that could be accomplished through web services and application program interfaces that are provided by the system, calling upon web services and application program interface functionality available through third party platforms such as Google Drive, Dropbox, Box, SharePoint, and YouTube.

Sources, Talk, and Work information may be geotagged in certain embodiments of the collaborative work apparatuses, systems and methods, with the tagging applied based on the location of the user or a specified location to support geospatial intelligence and geospatially-based matching.

To support strong collaboration opportunities, embodiments of the collaborative work apparatuses, systems and methods allow for Work to be conducted by one or more existing network or domain participants and may also permit Work to be conducted through an additional market network to allow for bidding of Work to be performed within a network inside or outside the collaborative work apparatuses, systems and methods, a domain inside or outside the collaborative work apparatuses, systems and methods, the personal connections of a member, or any combination of those. The bidding could include requests for proposals, proposals, selection processes and purchases of submitted deliverables, and rights, such as ownership and use rights, associated with the Work, for example.

Networks, Sources, Talk, Work and contributions of users within each can be rated on a scale, for example a scale of 1 to 10 with 1 being associated with a poor collaboration and 10 being associated with an optimum collaboration, by users in order to create points for users and weighting of the relative value of each Work, Talk, Source, network, or contributions contained therein by any users with access to such components of the system.

In addition, a system rating could be imported into the collaborative work apparatuses, systems and methods from external ratings and an internal rating may be derived, at least in part, by the amount of time that a given network, Source, Talk, or Work, or a portion of a given network, Source, Talk, or Work, is utilized.

User ratings and system ratings could be combined to form overall ratings in embodiments of the collaborative work apparatuses, systems and methods to provide a broad perspective of the value of those networks, Talk, Sources, and Work. Ratings could also be applied to users, for example, based on the ratings of the networks, Talk, Sources, and Work that are associated with each user because, for example, the user created, modified, or commented on a rated network, Talk, Source, or Work.

Embodiments of the present collaborative work apparatuses, systems and methods include an intelligent “Surfacing” function that will “Pop” (i.e. reveal) public networks of interest, new activities, new Sources, and new Talk, such as comments, new developments, new messaging threads, or new updates to existing threads, new work activities, new recommended connection options, potential work contract bidders, and potential work contract opportunities from both a push and pull perspective in the market network, all where access to those new activities and resources is permitted.

The Pop could be generated through a custom algorithm that weights multiple factors, including for example—(1) user defined preferences at registration; (2) search activities; (3) ratings and activities on networks, Sources, Talk, and Work; (4) activities among a user member's connections that may include user points and ratings; (5) geolocation to other users performing similar tasks or working on documents; (6) deep data mining of user activity compared to other users, for example the common use of uncommon words within a Source, Talk or Work file; and (7) most recent user activity on the system—to optimize the presentation of new information to the user that will be the most likely to be of interest to that user.

Certain embodiments of the collaborative work apparatuses, systems and methods may also use geolocation based, for example, either on user profile information or geotagging if the Sources, Talk, or Work is place-based, as a 6^{th} factor in generating Pops.

Embodiments of the collaborative work apparatuses, systems and methods may also generate Pops based on (7) user profile information, and (8) work product sample information.

Information may be stored and used, or “surfaced” in standard formats, for example for such items as files and lists, or information may be displayed in a map-based format, for example where geotagging is utilized to support geospatial information sharing. Such functionality is thought to deliver strong value in certain circumstances including military and first responder environments.

A Talk activity could, furthermore, become one or more Sources, as discussed herein, such as a document or other form of work product created through a collaboration between two members or an audio, video, or audio visual recording, for example that includes participants associated with each member that is maintained as a Source in the collaborative work system.

It may be noted that the collaborative work apparatuses, systems, and methods may include many of the functions discussed herein or smaller applications may be created that perform only one or more of the functions described herein. In that way, a corporate member may, for example, be a member of a collaborative work network and one or more of its employee and contractor members may also be members of the collaborative work network or a subnetwork of the collaborative work network and the individual members may be provided applications that have less than all of the functionality of the collaborative work network, but include the functionality of the collaborative work network that are frequently used by that individual.

Embodiments of work collaboration apparatuses, systems and methods may include a processor 950 coupled to a data storage device 962 and a network 12, such as the Internet or an intranet. The data storage device 962 may be used for storing files of information related to a work collaboration, including Source or resource files, Talk, which may include discussion threads or other documented exchanges related to a collaboration, and Work, which may include collaboration work products. The processor 950 may include instructions which, when executed by the processor 950, cause the processor 950 to perform desired functions. Those functions may include receiving a collaboration request from a first user operating on a first node 14, the first node 14 being any processing device including a computer, netbook, tablet, or mobile device. The instructions may further cause the processor 950 to transmit the collaboration request to at least a second node 16 and in many cases a number of nodes, such as user portal 18 having users that might be interested and capable of assisting in a collaboration. The instructions may further cause the processor 950 to receive one or more collaboration responses to the collaboration request from users of the second node 14 and potentially other nodes. The instructions may also cause the processor 950 to transmit the collaboration response to the first node 14, create a Talk thread that includes any number of collaboration requests and responses from any number of collaboration users and their nodes 14, 16, and 18. The instructions may cause the processor 950 to receive one or more links to one or more documents related to the collaboration requested and those documents may be stored on the data storage device 962 or may not be stored on the data storage device 962, but may, rather, be stored in in other storage devices 30 accessible through the Internet or another network. The instructions may also cause the processor 950 to receive a modification to the document related to the collaboration, store the modification to the document related to the collaboration in the data storage device 962 and communicate the document link to at least the first node 14 and the second node 16.

The processor 950 may be coupled to the data storage device through the network and the processor may be incorporated into a computing device or server that has any or all of the components illustrated in FIG. 8 or described herein. Users may, furthermore, access the work collaboration apparatuses or system using various forms of nodes, such as the user portals illustrated in FIG. 1, to connect to the system network and interact with the system.

The modifications to the documents related to the collaboration that are not stored on the data storage device may include, for example, comments related to that document and a rating or score associated with that document. Scores that are related to a document may also include scores for a user that provided that document. A user score may also include the perceived value of the user as input into the system by another user.

Embodiments of work collaboration apparatuses, systems and methods may include preparing a request for proposal based on instructions received from a user and forwarding the request for proposal to another user with links to documents, Sources, Text, or Work related to the collaboration requested that or and are not stored in the work collaboration system and links to modifications to those documents that are stored on the data storage device.

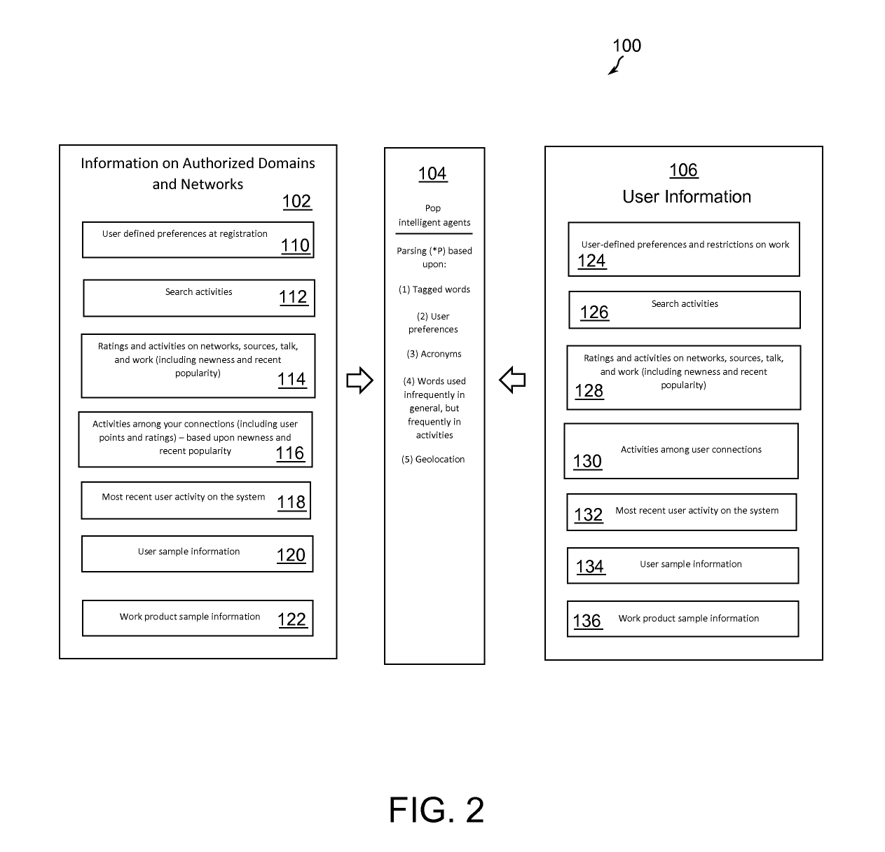

FIG. 2 illustrates information that is available in an embodiment of work collaboration 100. That embodiment includes information on authorized domains and networks 102, Pop intelligent agents 104 and user information 106.

Information on authorized domains and networks 102 may include preferences 110 that a user may define at registration and may further define or update after registration. That information may also include a record of search activities 112 and further may display such search activities with priority given to search activities that are related to one or more search criteria.

Ratings for a domain 114 may also be provided in the information on authorized domains and networks 102. Domain or network ratings 114 may be based on activity on the domain network, Sources connected to the domain, Talk provided to the domain network, Work performed on the domain network, temporal activity on the domain network (e.g., the more recent the activity the higher the score), and feedback received from other users of the domain.

Activities of a user's user connections on the domain network 116 is another piece of information that may be available for a domain and its associated network, as well as a user's recent activity 118, sample information from a user 120, and sample work product of a user 122. Certain items, such as the latter two pieces of information (sample information 120 and sample work product 122) may be provided only under certain circumstances, such as when that user is participating in a contract or bidding situation.

The Pop intelligent agents 104 may provide one or more users of the work collaboration apparatus, system, or method of happenings on the domain or network based on such things as tagged words in Talk or Source added to the domain or network, occurrence of user preferences such as preferred words that were provided in a user profile, whether at registration or at another time, acronyms included in a user profile or otherwise indicated as acronyms of interest by a user, occurrence of words that are infrequently used in general but are frequently used in activities of the user, and geolocation, whether a location of a user or a location desired by the user. Pop intelligent agents 104 and factors used to determine when a Pop should occur may apply to information on authorized domains or networks 102 or user information 106 and may be weighted, for example, based on the importance of a factor in general or to a particular user. The resulting Pops may be introductions to other users that the work collaboration apparatuses, systems and methods determine may be of interest to a user, to Sources that may be of interest to the user, or to Talk that may be of interest to the user.

User information 106 may include user defined preferences and restrictions on types of work that the user is or is not interested in performing 124, search activities 126, and ratings and activities 128, which may include ratings on the network or related networks, activities on the network, and ratings and activities related to Sources, Talk and Work on this or a related network. Ratings may be based, at least in part, on the newness and recent popularity of activity by the user. User information 106 may also include activities of a user's connections 130, which may include user points and ratings of those connections and the newness and recent popularity of those connections, since a user with good connections may themselves be a good user for connection. User information 106 may also consider recent activity of a user and the type of activity that user has engaged in recently 132, and may include user sample information 134 or user work product sample information 136. Again, certain items, such as sample information 134 and sample work product 136 may be provided only under certain circumstances, such as when that user is participating in a contract or bidding situation.

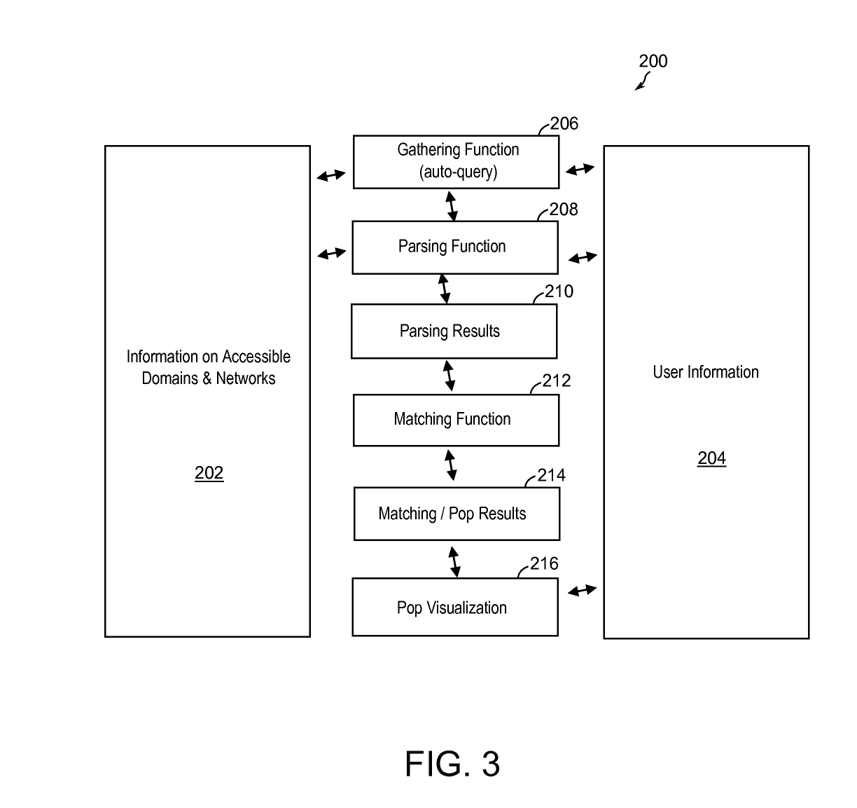

FIG. 3 illustrates an embodiment of the exchange of domain and network information with user information to create ratings 200. A process for exchanging domain and network information with user information to create ratings 200 may operate continuously or periodically and may operate with or without user queries. In that embodiment, information on accessible domains and networks 202 is gathered automatically 206 and user information 204 is gather automatically 206. Parsing 208 is performed on network and user information. Such parsing may be performed in accordance with the Pop intelligent agent 104 described hereinbefore. Results 210, which may include rankings and probabilities that information will be useful, are determined and information is matched 212 to appropriate users, potentially using weighing of the information and restrictions established by a user. If matches are established, the matched Source, Talk, Work, or user associated with such Source, Talk or Work is placed in Pop format 214 to be provided to a user 216 who is determined to have a match. Such a user Pop 216 may be provided or visualized by the user in a variety of ways including, for example, on a general purpose computer, a mobile device app, or a web application.

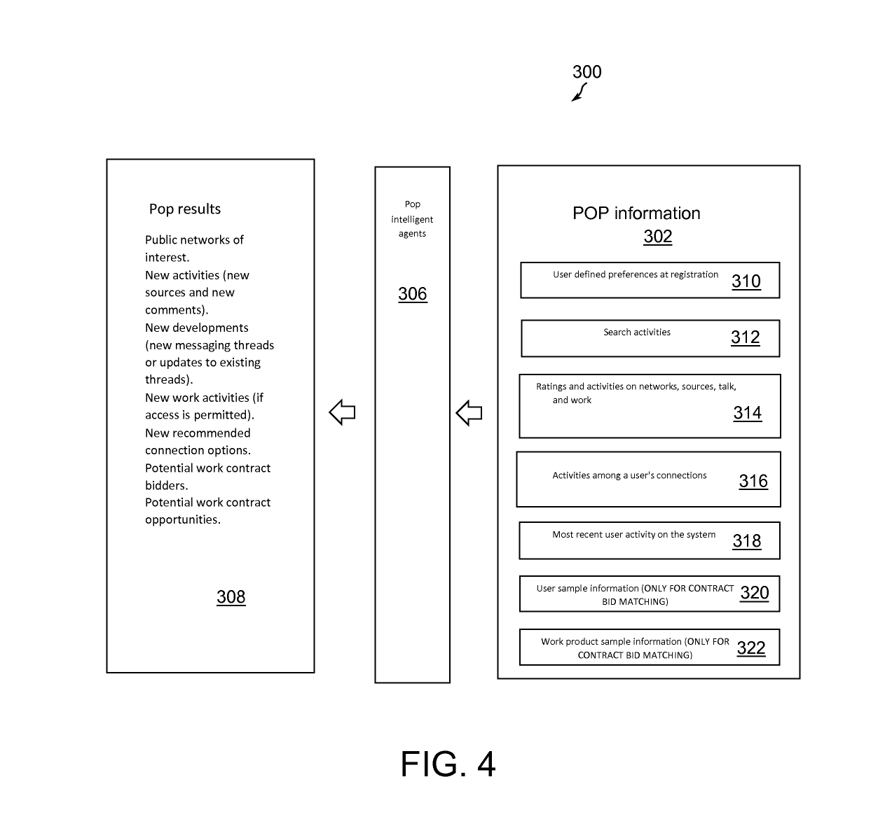

FIG. 4 illustrates Pop operation 300 in an embodiment of work collaboration apparatuses, systems, and methods, such as the collaboration system 10, for example. In that embodiment, information similar to that shown and described as User Information 106 in connection with FIG. 2 is provided under Pop information 302. That Pop information 302 may include user defined preferences and restrictions on types of work that the user is or is not interested in performing 310, search activities 312, and ratings and activities 314, which may include ratings on the network or related networks, activities on the network, and ratings and activities related to Sources, Talk and Work on this or a related network. Ratings may be based, at least in part, on the newness and recent popularity of activity by the user. Pop information 302 considered in creating a Pop may also include activities of connections to a user who is being considered for receipt of a Pop 316, which may include user points and ratings of those connections and the newness and recent popularity of those connections. Pop information 302 may also include recent activity of the user being considered for a Pop and the type of activity that user has engaged in recently 318, and may include user sample information 320 or user work product sample information 322. Again, certain items, such as sample information 320 and sample work product 322 may be provided only under certain circumstances, such as when that user is participating in a contract or bidding situation.

Pop intelligent agents such as 104 described herein weigh the Pop information 302 to determine whether a Pop should be sent to a user 308. Pop results 308 include providing links to users to other users that may be of interest to them, to Sources that may be of interest, to Talk, including dialog threads that may be of interest to the user, and to Work that may be of interest to a user. For example, a Pop may inform a user of public or private networks that the user may want to consider or join, new activities, such as Talk and Sources, on a network with which the user is already associated, or new developments or work activities. A Pop may also provide a recommendation for a connection to another user or a new network or domain, another potential bidder for a Work contract, or a potential opportunity for the user to vie for a Work contract.

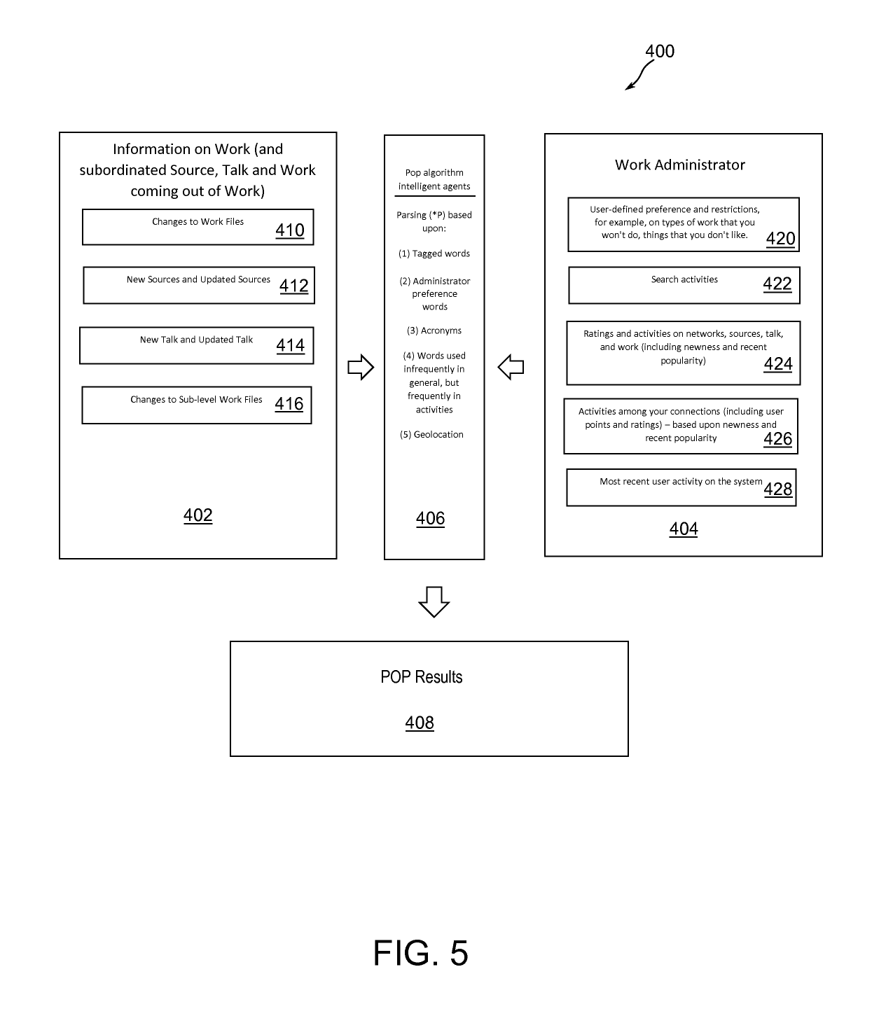

FIG. 5 illustrates an embodiment of Work administrator interaction with the work collaboration apparatuses, systems, and methods 400 wherein information on Work being performed 402 and Work Administrator defined information 404 are processed by Pop intelligent agents 406 to provide Pop reports and results 408 to the Work administrator or another designated user.

Information on Work being performed 402 may include portions of Work, such as Sources, Talk, and Work that is associated with or comes from a particular Work project. Information on Work being performed 402 may also include changes made to Work files 410, new Sources and updated Sources 412, new Talk and updated Talk 414, and changes to Work files 416 that are a part of or related to a Work project being considered. Information on Work may be provided through a survey of information related to a Work project, including Work project related items, titles, content, users, and when such things were added or updated.

Work administrator information 404 may include user defined preferences and restrictions 420, administrator search activities 422, and administrator ratings and activities on networks, Sources, Talk and Work, which may include a factor of more significance when the activity is newer (and a lower factor for older activities, making those older activities less significant that newer activities) or a higher importance factor for activities that are popular or rated highly by others on the Work network than for activities that are less popular or not as highly rated. Work administrator information 404 may also include activities among the administrator's connections 426, which may include points and ratings applied to a Source, Tal k, or Work activity and may also have significance added due to timing or popularity among the administrator's connections and Work administrator activity may include recent user activity 428 on the work collaboration system, domain, or network.

Information on Work being performed 402 and Work administrator information 404 may be provided to the Pop intelligent agents 406 to provide the administrator of the work collaboration apparatus, system, or method of happenings on the domain or network based on such things as tagged words in Talk or Source added to the domain or network, occurrence of user preferences such as preferred words that were provided in a user profile, whether at registration or at another time, acronyms included in a user profile or otherwise indicated as acronyms of interest by a user, occurrence of words that are infrequently used in general but are frequently used in activities of the user, and geolocation, whether a location of a user or a location desired by the user. Pop intelligent agents 406 and factors used to determine when a Pop should occur may apply to information related to or making up a Work project 402 or administrator information 404 and may be weighted, for example, based on the importance of a factor in general or to a particular user. The resulting Pops may be introductions to other users that the work collaboration apparatuses, systems and methods determine may be of interest to a user, to Sources that may be of interest to the user, or to Talk that may be of interest to the user.

Pop results and reports 408 may be provided to the administrator based on the Pop intelligent agents 406. Such results may be based upon parsing, weighing, and matching to determine the most relevant and critical updates for the administrator. Such results may also indicate to the administrator an identification of who made an update, when that update was made and what updates were made.

Reports could also be provided to the administrator based on the Pop intelligent agents 406. Those reports could include scores for participants in a Work project, for example, and such a report might be further based on such things and the number and scale of that participant's input into the Work project and the ratings of that participant in the Work collaboration apparatus or system.

Another report that could be provided by Pop intelligent agents 406 could include the identity at a desired level of detail of changes to Work files, new Sources, updated Sources, new Talk, updated Talk, and changes to sublevel Work files.

Pops may be driven by parsing, weighting and matching functionalities and can be utilized to support management of massively multi-participant online work collaboration. An embodiment of work collaboration apparatuses, systems, and methods can be used to support small numbers or extremely large numbers of people working, cooperatively or competitively, on a large scale, with meaningful interaction with people around the world.

As significant as the capability to effectively support collaborative activities within networks using Work, Talk, Sources and subordinate level Work under a Work dataset, work collaboration apparatuses, systems, and methods can allow for effective management and monitoring of activities by generating full and targeted reports, including real-time reports using Pop with targeted reports based upon parsing, weighting and matching functionalities. Such targeted reports are thought to create strong efficiency for large work collaborations.

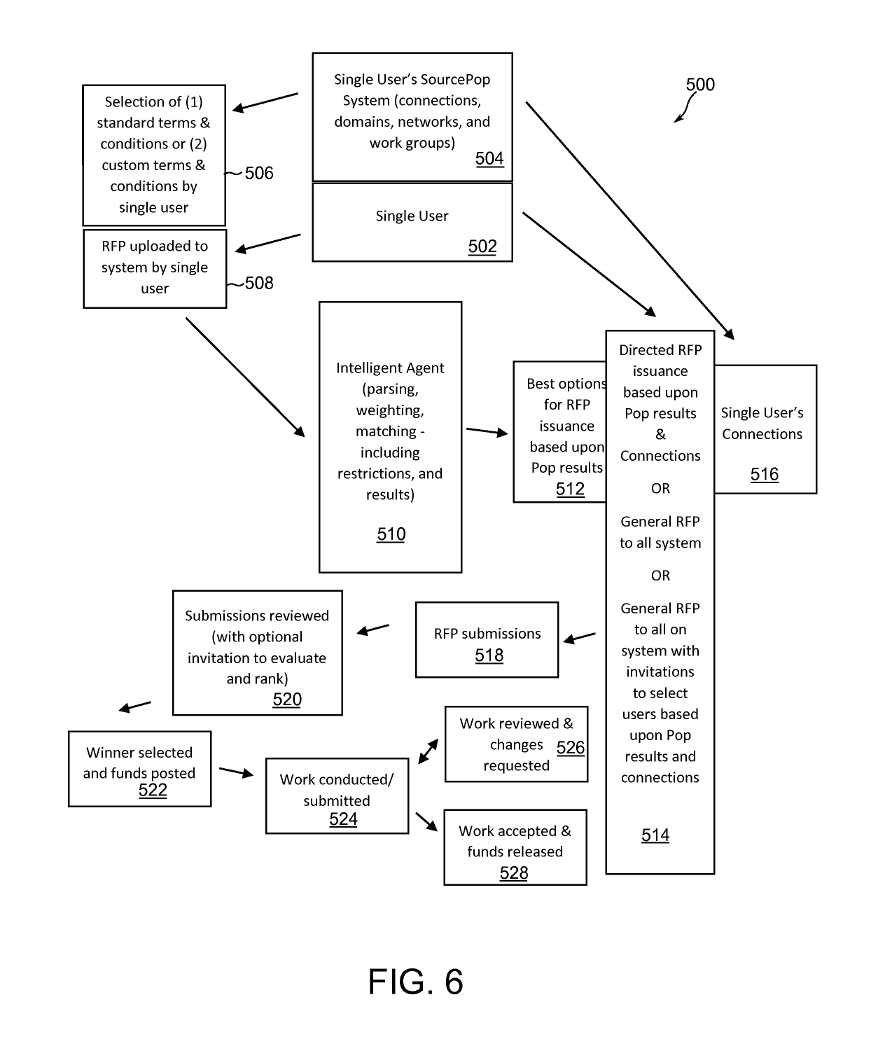

FIG. 6 illustrates a contracting selection process 500 that may be used to support collaborative work that is fee-based, as opposed to collaboration without fee payment, although both types of work are supported on work collaboration apparatuses and systems.

It may be noted that non-fee based work may be accomplished through the Work function in a crowd-sourced environment, in which Work may be restricted by authorized domains, networks, and invitation to join work groups, while fee-based work may be managed through the market capability of the work collaboration apparatuses, systems, and methods and may also be crowd-sourced.

The embodiment of the contracting selection process 500 is illustrated in FIG. 6 from the perspective of a single user 502. The single user 502 is a user of a SourcePop work collaboration system 504. Using the SourcePop work collaboration system 504, the user can select to contract based on standard terms and conditions included in the system 504 or by creating custom terms and conditions at 506. A request for proposal that includes the terms and conditions selected by the user is then uploaded by the user to the system 504 at 508. At 510, the system 504 uses the intelligent agent, such as may be found at 104 or 406, to select potential users to which to issue the request for proposal by parsing the requirements of the contract and comparing those requirements with the system 504 known abilities of other users, weighing the extent of the know abilities of other users in the system 504 and providing a preference for those users who appear to have more experience in the areas desired in the contract, and/or matching the contract to users in the system 504. The system 504 may then suggest the best users in the system 504 for accomplishing the goals, terms, and conditions of the contract to the user 502 at 512. The user 502 may then direct the request for proposal to all or some of the system 504 suggested users from 512 at 514. Alternately, at 514, the user 502 may send the request for proposal to all users of the system 504. In another alternative, the user 502 may request that additional users submit their abilities to the user 502 so that the user 502 can select additional users for its request for proposal, hereby acquiring a larger base for its request for proposal at 514.

At 516, the user 502 may also submit its request for proposal to other users known to the requesting user 502.

At 518, the users who submit proposals to the requesting user 502 can submit those proposals through the system 504. Those proposals may then be reviewed by the requesting user 502 and, optionally, the submissions received may be evaluated and ranked by the system 504 at 520. At 522, a winning proposal can be selected by the requesting user 502 and, if desired, funds may be posted by the user 502 for keeping by the system 504 and provision to the selected user upon completion of the terms and conditions of the contract. At 524, the agreed work is performed by the selected user and, when completed, is submitted to the requesting user 502. At 526, the work is reviewed by the requesting user 502 and changes, if any are desired, or questions, if any arise, may be provided to the selected user by the requesting user 502. At 528, the work that was requested and completed is accepted by the requesting user 502 and the funds are released to the user who completed the work by the system 504.

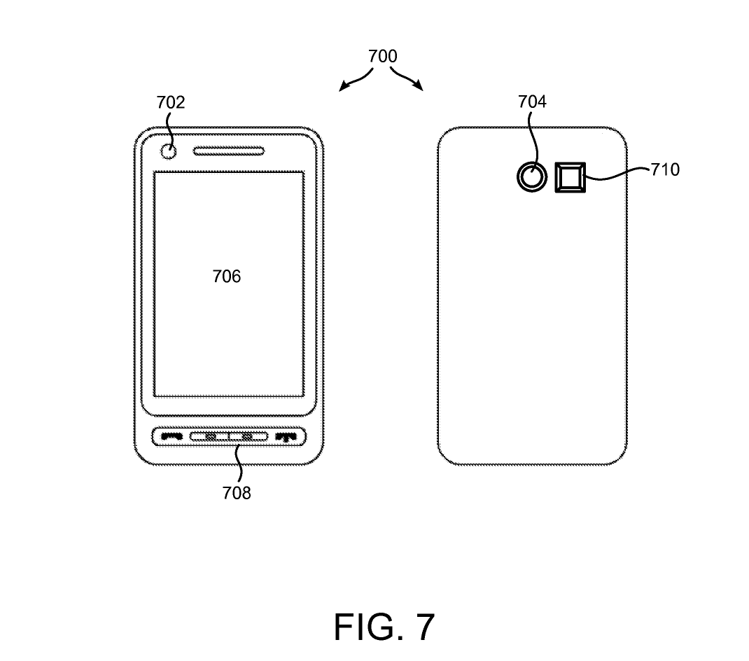

FIG. 7 illustrates a mobile device 700 that may be used in embodiments of collaboration apparatuses, systems, and methods as described herein, such as the collaboration system 10, for example. The mobile device 700 illustrated includes a front camera 702, a rear camera 704, a screen 706, and control buttons 708. The mobile device 700 may also contain computing devices as described herein or otherwise included in such mobile devices 700, including a processor 950 or microprocessor and memory 952 and may have stored thereon various software applications. The mobile device may furthermore be handheld, as is illustrated in FIG. 5, or it may be formed in a wrist bound form, on glasses, or otherwise as desired. Thus, in one embodiment, collaboration software may be installed and operate on the mobile device.

FIG. 8 illustrates computing device hardware 910 that may be used in embodiments of collaboration apparatuses, systems, and methods as described herein. As shown in FIG. 8, the computing device 910 may include a processor 950, memory 952, a storage device 962, a coupling for an output device 964, a coupling for an input device 966, a communication adaptor 968, and a camera 902. Communication between the processor 950, the storage device 962, the output device coupling 964, the input device coupling 966, and the communication adaptor 968 is accomplished by way of one or more communication busses 970. It should be recognized that the control circuitry 910 may have fewer components or more components than shown in FIG. 8. For example, if a user interface is not desired, the input device coupling 966 or output device coupling 964 may not be included with the control circuitry 910.

The memory 952 may, for example, include random access memory (RAM), dynamic RAM, or read only memory (ROM) (e.g., programmable ROM, erasable programmable ROM, or electronically erasable programmable ROM) and may store computer program instructions and information. The memory 952 may furthermore be partitioned into sections including an operating system partition 958 where system operating instructions are stored, and a data partition 956 in which data is stored.

The processor 950 may be any desired processor or microprocessor, including a processor in a mobile device or tablet or a processor in a general purpose computer or server. The processor 950 may, for example, be an Intel® type processor or another processor manufactured by, for example AMD® or Oracle®. The processor 950 may furthermore execute the program instructions and process the data stored in the memory 952. In one embodiment, the instructions are stored in memory 952 in a compressed or encrypted format. As used herein the phrase, “executed by a processor” is intended to encompass instructions stored in a compressed or encrypted format, as well as instructions that may be compiled or installed by an installer before being executed by the processor 950.

The storage device 962 may, for example, be non-volatile battery backed SRAM, a magnetic disk (e.g., hard drive), optical disk (e.g., CD-ROM) or any other device or signal that can store digital information. The communication adaptor 968 permits communication between the computer 910 and other devices or nodes coupled to the communication adaptor 968 at the communication adaptor port 972. The communication adaptor 968 may be a network interface that transfers information from a node such as a general purpose computer to the computing device 910 or from the computing device 910 to a node. It will be recognized that the computing device 910 may alternately or in addition be coupled directly to one or more other devices through one or more input/output adaptors (not shown).

The input device coupling 966 and output device coupling 964 may couple one or more input or output devices. It will be recognized, however, that the computing device 910 does not necessarily need to have an input device or an output device to operate. Moreover, the storage device 962 may also not be necessary for operation of the computer 910 as data may be stored in memory, for example. Data may also be stored remotely and accessed over a network, such as the Internet.

The elements 950, 952, 962, 964, 966, and 968 related to the computing device 910 may communicate by way of one or more communication busses 970. Those busses 970 may include, for example, a system bus or a peripheral component interface bus.

The camera 902 may be a variety of image acquisition devices and sensors, including, for example, a digital camera including a digital single-lens reflex (DSLR) camera, a camera in a mobile device such as an Android device or iPhone, a thermal camera, a photonic capture device, or another device that can capture an image and transfer that image to a processor 950 or storage device 952. The camera 902 may be any camera including a camera that is a part of a computer device, such as a mobile device or a tablet computing device, or may be a camera that captures an image digitally and transmits that image to a computing device.

While the present invention has been disclosed with reference to certain embodiments, numerous modifications, alterations, and changes to the described embodiments are possible without departing from the scope of the present invention, as defined in the appended claims. Accordingly, it is intended that the present invention not be limited to the described embodiments, but that it have the full scope defined by the language of the following claims, and equivalents thereof.

What is claimed is:

1. A work collaboration system, comprising:
a data storage device for storing a file of information related to a work collaboration; and
a processor coupled to the data storage device and a network for receiving a collaboration request from a first node coupled to the network and communicating the collaboration request to a second node coupled to the network, the processor having instructions which, when executed by the processor, cause the processor to:
receive the collaboration request from the first node;
transmit the collaboration request to at least the second node;
receive a collaboration response to the collaboration request from the second node;
transmit the collaboration response to the first node;
create a Talk thread that includes the collaboration request and the collaboration response;
receive a link to a document related to the collaboration request that is not stored in the work collaboration system from one of the first node and the second node;
receive a modification to the document related to the collaboration request from one of the first node and the second node;
store the modification to the document related to the collaboration request in the data storage device; and
communicate the document link to the first node and the second node.

2. The work collaboration system of claim 1, wherein the processor is coupled to the data storage device through the network.

3. The work collaboration system of claim 1, wherein the processor further comprises a server.

4. The work collaboration system of claim 1, further comprising at least two user nodes connected to the network, one of the user nodes being the second node.

5. The work collaboration system of claim 1, wherein the Talk thread includes text exchanged between the first node and the second node, the text stored in the data storage device.

6. The work collaboration system of claim 1, wherein the modification to the document related to the collaboration request that is not stored in the work collaboration system includes at least one of a comment related to that document and a rating associated with that document.

7. The work collaboration system of claim 1, wherein the processor further includes instructions which, when executed by the processor, cause the processor to create a score for a user of the second node that indicates the activity of the user of the second node on the system.

8. The work collaboration system of claim 7, wherein the processor further includes instructions which, when executed by the processor, cause the processor to modify the score for the user of the second node based on the perceived value of the user of the second node as input into the system by a user of the first node.

9. The work collaboration system of claim 1, wherein the processor further includes instructions which, when executed by the processor, cause the processor to create a score for a user of the first node that indicates the activity of the user of the first node on the system.

10. The work collaboration system of claim 9, wherein the processor further includes instructions which, when executed by the processor, cause the processor to modify the score for the user of the first node based on the perceived value of the user of the first node as input into the system by the user of the second node.

11. The work collaboration system of claim 1, wherein the processor further includes instructions which, when executed by the processor, cause the processor to:
prepare a request for proposal based on instructions received from the first node; and
forward the request for proposal to the second node with the link to the document related to the collaboration request that is not stored in the work collaboration system and a link to the modification to the document stored on the data storage device.

12. The work collaboration system of claim 11, wherein the processor further includes instructions which, when executed by the processor, cause the processor to forward a link to text related to the request for proposal that was created by the first node and at least one third node, the linked text being stored on the data storage device.

13. The work collaboration system of claim 12, wherein the processor further includes instructions which, when executed by the processor, cause the processor to forward a link to Work related to the request for proposal that was created by the first node and at least one third node, the linked Work being stored on the data storage device.

14. A work collaboration method, comprising a computer system:
receiving a collaboration request from a first user;
transmitting the collaboration request to a second user;
receiving a collaboration response from the second user;
transmitting the collaboration response to the first user;
creating a Talk thread that includes the collaboration request and collaboration response;
receiving a link to a remotely stored document related to the collaboration request, the remotely stored document being accessible to the computer system through a network;
receiving a modification to the remotely stored document related to the collaboration request and storing that modification in a data storage device coupled to the computer system; and
communicating the document link to the first user and the second user.
